(19) United States
(12) Patent Application Publication
(10) Pub. No.: US 2025/0245328 A1
(43) Pub. Date: Jul. 31, 2025

(54) RANSOMWARE DEFENSE AND ANALYSIS BASED ON KERNEL TELEMETRY DATA

(71) Applicant: Mimic Networks, Inc., Palo Alto, CA (US)

(72) Inventors: Michael Burtscher, Chicago, IL (US); Chi Zhang, Brookline, MA (US); Kirby Kuehl, Portland, OR (US); Scott Young, Ashburn, VA (US); Carl Schroeder, Los Altos, CA (US); Timothy Worsley, Snoqualmie, WA (US); Adam Woodbeck, White Lake, MI (US)

(73) Assignee: Mimic Networks, Inc., Palo Alto, CA (US)

(21) Appl. No.: 19/040,491

(22) Filed: Jan. 29, 2025

Related U.S. Application Data
(60) Provisional application No. 63/626,462, filed on Jan. 29, 2024.
(60) Provisional application No. 63/626,467, filed on Jan. 29, 2024.

(51) Int. Cl. G06F 21/56; G06F 21/54; G06F 21/55

(52) U.S. Cl. CPC G06F 21/568; G06F 21/54; G06F 21/552

(57) ABSTRACT

Techniques are provided for ransomware defense and analysis based on kernel telemetry data. System calls initiated by processes executing on a computer system are monitored. Kernel telemetry data is generated for a plurality of system calls, the kernel telemetry data associating, for each system call of the plurality of system calls, a process invoking the system call, an operation type of the system call, and a target of the system call. The kernel telemetry data is analyzed. Based on analyzing the kernel telemetry data, it is determined that a particular process executed under control of a ransomware agent. In response to determining that the particular process executed under the control of the ransomware agent, one or more response measures are initiated.

### CROSS-REFERENCE TO RELATED APPLICATIONS; BENEFIT CLAIM

This application claims the benefit of U.S. Provisional Application Ser. No. 63/626,462, filed Jan. 29, 2024, and U.S. Provisional Application Ser. No. 63/626,467, filed Jan. 29, 2024, the entire contents of which are hereby incorporated by reference as if fully set forth herein, under 35 U.S.C. § 119(e).

### FIELD OF THE DISCLOSURE

The present disclosure generally relates to security techniques, and relates more specifically to protecting computer systems against ransomware agents.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely based on their inclusion in this section.

Endpoint Detection and Response (EDR) systems are typically used to protect endpoints in an enterprise network from malicious software (malware), including ransomware. Extended Detection and Response (XDR) systems expand the scope of protection beyond individual endpoints to an enterprise's IT environment. These solutions are often based on the analysis of endpoint and network telemetry data. EDR systems and XDR systems operate in noisy environments with high activity levels and large traffic volumes involving many different actors, applications, platforms, and devices. The amount of noise in the endpoint telemetry data and the network telemetry data collected in these environments can negatively affect threat detection accuracy. Techniques are needed to address these limitations.

### SUMMARY

The appended claims may serve as a summary.

### BRIEF DESCRIPTION OF THE DRAWINGS

In the drawings:

FIG. 1 illustrates a computer system that includes a ransomware defense system in an example embodiment.

FIG. 2 illustrates a protected computer in an example embodiment.

FIG. 3 is a flow diagram of a process for ransomware defense in an example embodiment.

FIG. 4 illustrates a computer system upon which an embodiment may be implemented.

While each drawing figure illustrates a particular embodiment for the purpose of providing a clear example, other embodiments may omit, add to, reorder, or modify any of the elements shown in the drawing figures. Unless otherwise specified, aspects disclosed with respect to an embodiment of an element in a figure may optionally be applied to another embodiment of the element in another figure. For purposes of illustrating clear examples, one or more figures may be described with reference to one or more other figures. However, using the particular arrangement illustrated in such other figure/s is not required in other embodiments.

### DETAILED DESCRIPTION

In the following description, numerous specific details are set forth in order to provide a thorough understanding of the subject matter of the present application. It will be apparent, however, to a person of ordinary skill that embodiments may be practiced without incorporating all aspects of the specific details described herein. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “includes”, “including”, “comprises”, and/or “comprising” specify the presence of stated features but do not preclude the presence or addition of one or more other features. Unless otherwise specified: “such as” is intended to mean “such as but not limited to”; and examples are intended to be nonlimiting.

As used herein, the term “component” refers to any element, module, device, part, hardware, software, firmware, or any combination thereof. As an alternative and/or addition, a component may comprise specialized circuitry and/or or mechanical assemblies designed to perform specific functions. A component may be a standalone component, work in conjunction with one or more other components, contain one or more other components, and/or belong to one or more other components. A component may perform specific functions, interact with other components, provide structure, and/or achieve certain operations.

As used herein, the terms “coupled” refers to a connection between two components, which may be direct or indirect, permitting additional intermediary components, elements, structures, or mechanisms between the coupled components. Such connections may encompass, but are not limited to, communicative connections (e.g., electronic, optical, wireless, and/or other communication pathways), mechanical connections, electromagnetic connections, and/or any other form of functional, operative, or interactive association.

As used herein, the term “system” refers to mechanical components, hardware, and/or software stored in, or coupled with, a memory and/or one or more processors on one or more computers. As an alternative and/or addition, a component may comprise specialized circuitry and/or or mechanical assemblies designed to perform specific functions. A system may be a standalone component, work in conjunction with one or more other systems, contain one or more other systems, and/or belong to one or more other systems. A system may be a computer system, mechanical system, or an integrated system that combines both mechanical and computational elements.

As used herein, the term “computer” refers to any apparatus, electronic device, or system capable of processing data, executing instructions, and/or performing calculations. A computer may include one or more controllers, processors, memory, input/output interfaces, storage devices, and/or any combination thereof. The term encompasses both virtual computers and/or hardware computers, including desktop computers, laptop computers, server computers, edge devices, cloud-based systems, embedded systems, controllers, microcontrollers, and other programmable devices. It applies to standalone and/or networked devices and may include software, firmware, and/or hardware for computational functions.

As used herein, the term “computer system” refers to one or more computers, such as one or more hardware computers, virtual computers, and/or computing devices. For example, a computer system may be, or may include, one or more server computers, desktop computers, laptop computers, mobile devices, special-purpose computing devices with a processor, cloud-based computers, cloud-based clusters of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

As used herein, the term “device” refers to a mechanical system, a computer system, hardware, and/or software stored in, or coupled with, a memory and/or one or more processors on one or more computers. As an alternative and/or addition, a device may comprise specialized circuitry and/or or mechanical assemblies designed to perform specific functions. A device may be a standalone device, work in conjunction with one or more other devices, contain one or more other devices, and/or belong to one or more other devices.

A “client” refers to a combination of integrated software components and an allocation of computational resources, such as memory, a computing device, and/or processes on a computing device for executing the integrated software components. The combination of the software and the computational resources is configured to interact with one or more servers over a network, such as the Internet. A client may refer to either the combination of components on one or more computers, or the one or more computers (also referred to as “client computing devices”).

A “server” refers to a combination of integrated software components and an allocation of computational resources, such as memory, a computing device, and/or processes on the computing device for executing the integrated software components. The combination of the software and the computational resources is dedicated to providing a particular type of function on behalf of clients of the server. A server may refer to either the combination of components on one or more computing devices, or the one or more computing devices (also referred to as a “server system”). A server system may include multiple servers; that is, a server system may include a first computing device and a second computing device, which may provide the same or different functionality to the same or different set of clients.

### General Overview

This document generally describes systems, methods, devices, and other techniques for ransomware defense and analysis based on kernel telemetry data. A ransomware defense system is deployed on one or more computer systems, such as a physical computer or virtual computer. For example, the ransomware defense system may be deployed on one or more enterprise computers that run critical applications. A kernel monitoring component of the ransomware defense system monitors system calls initiated by processes on a computer and generates kernel telemetry data corresponding to a plurality of system calls. The kernel telemetry data describes the kernel-level behavior of one or more processes. The ransomware defense system analyzes the kernel telemetry data to determine when a particular process executed under the control of a ransomware agent. For example, the kernel telemetry data may be analyzed to detect patterns of kernel-level behavior that are consistent with ransomware activity.

As used herein, the term “ransomware agent” refers to any entity, such as software, hardware, organizations, human actors, and/or any combination thereof, that seizes, encrypts, alters, disrupts, and/or otherwise restricts access to one or more resources, data, systems, networks, devices, and/or other assets. For example, a ransomware agent may include a human actor entering commands to carry out activity performed by a ransomware agent. Activity performed by a ransomware agent to carry out its objectives is referred to herein as “ransomware activity.” As used herein, the term “ransomware” refers to ransomware agent/s comprising a computer program, application, and/or other executable code. A ransomware agent may condition the restoration of access, functionality, or avoidance of further harm upon fulfilling one or more demands. For example, ransomware agents may demand payment in exchange for encryption keys necessary for decryption. Ransomware agents may also exfiltrate data from the computer system, and may demand payment in exchange for not releasing the exfiltrated data.

Ransomware is explicitly referenced in the context of one or more embodiments. It is to be understood, however, that the techniques described herein may be adapted to other forms of malicious activity, malicious agents, and/or malware without departing from the spirit or the scope of the disclosure. For example, one or more techniques described herein may be adapted to patterns of kernel-level behavior that are consistent with processes executed under the control of other forms of malicious activity, malicious agents, and/or malware.

One aspect of the disclosure is directed to a non-transitory computer-readable medium storing instructions that, when executed by one or more processors, cause the one or more processors to: monitor system calls initiated by processes executing on a computer system; generate kernel telemetry data for a plurality of system calls, the kernel telemetry data associating, for each system call of the plurality of system calls, a process invoking the system call, an operation type of the system call, and a target of the system call; analyze the kernel telemetry data; based on analyzing the kernel telemetry data, determine that a particular process executed under control of a ransomware agent; and in response to determining that the particular process executed under the control of the ransomware agent, initiate one or more response measures.

In some examples, monitoring the system calls is performed in kernel space of the computer system; the instructions, when executed by one or more processors, cause the one or more processors to: provide the kernel telemetry data to a user space application component executing in user space of the computer system; and analyzing the kernel telemetry data is performed by the user space application component.

In some examples, determining that the particular process executed under the control of the ransomware agent comprises detecting a hallmark in particular kernel telemetry data corresponding to the particular process, the hallmark comprising a first pattern of kernel-level behavior consistent with ransomware execution.

In some examples, the hallmark comprises a pattern of kernel-level behavior associated with a particular ransomware variant.

In some examples, the hallmark comprises deviation from typical kernel-level behavior of the particular process.

In some examples, the hallmark comprises a pattern of file access relating to file encryption.

In some examples, the hallmark comprises a pattern of file access relating to exfiltration of data.

In some examples, the hallmark comprises modification of system configuration data.

In some examples, the hallmark comprises a pattern associated with modifying one or more processes related to security.

In some examples, the hallmark comprises a pattern associated with modifying access control configurations.

In some examples, the one or more response measures comprise preventing execution of a corresponding system call associated with the particular process.

In some examples, the one or more response measures comprises terminating the particular process.

In some examples, the one or more response measures comprise initiating a remediation process to address ransomware on the computer system.

One aspect of the disclosure is directed to a method comprising: monitoring system calls initiated by processes executing on a computer system; generating kernel telemetry data for a plurality of system calls, the kernel telemetry data associating, for each system call of the plurality of system calls, a process invoking the system call, an operation type of the system call, and a target of the system call; analyzing the kernel telemetry data; based on analyzing the kernel telemetry data, determining that a particular process executed under control of a ransomware agent; and in response to determining that the particular process executed under the control of the ransomware agent, initiating one or more response measures; wherein the method is performed by one or more processors.

In some examples, monitoring the system calls is performed in kernel space of the computer system; the method comprises providing the kernel telemetry data to a user space application component executing in user space of the computer system; and analyzing the kernel telemetry data is performed by the user space application component.

In some examples, determining that the particular process executed under the control of the ransomware agent comprises detecting a hallmark in particular kernel telemetry data corresponding to the particular process, the hallmark comprising a first pattern of kernel-level behavior consistent with ransomware execution.

In some examples, the hallmark comprises a pattern of kernel-level behavior associated with a particular ransomware variant.

In some examples, the hallmark comprises deviation from typical kernel-level behavior of the particular process.

In some examples, the hallmark comprises at least one of: a pattern of file access relating to file encryption; a pattern of file access relating to exfiltration of data; modification of system configuration data; a pattern associated with modifying processes related to security; and a pattern associated with modifying access control configurations.

One aspect of the disclosure is directed to a computer system comprising: one or more hardware processors; at least one memory storing one or more instructions which, when executed by the one or more hardware processors, cause the one or more hardware processors to: monitor system calls initiated by processes executing on the computer system; generate kernel telemetry data for a plurality of system calls, the kernel telemetry data associating, for each system call of the plurality of system calls, a process invoking the system call, an operation type of the system call, and a target of the system call; analyze the kernel telemetry data; based on analyzing the kernel telemetry data, determine that a particular process executed under control of a ransomware agent; and in response to determining that the particular process executed under the control of the ransomware agent, initiate one or more response measures.

In some implementations, the various techniques described herein may achieve one or more of the following advantages: ransomware executing on a computer system and/or enterprise network may be more quickly and accurately detected; ransomware deflection may be performed earlier and/or more effectively; the effects of the ransomware execution may be prevented and/or mitigated; ransomware detection and deflection techniques may be performed based on low-noise data sets; accuracy of ransomware detection may be improved; ransomware detection and deflection techniques may quickly adapt to new ransomware variants; vulnerabilities in enterprise systems and/or critical applications may be detected at an early stage of development; ransomware defenses may be validated before deployment in a staging or production environment; and ransomware behavior may be analyzed in an isolated environment. Additional features and advantages are apparent from the specification and the drawings.

### System Overview

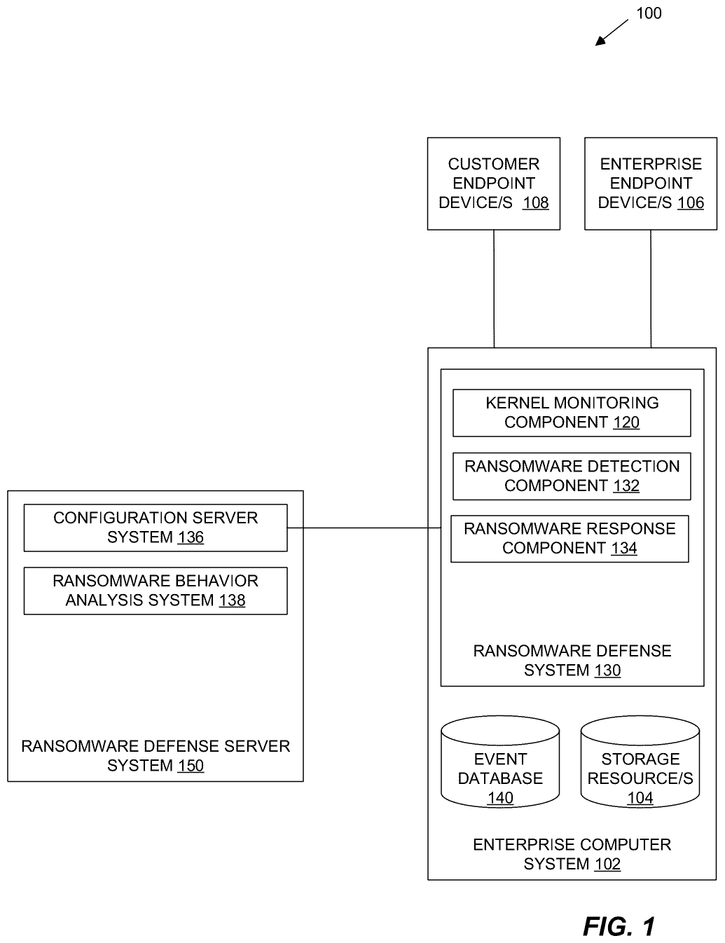

FIG. 1 illustrates a computer system that includes a ransomware defense system in an example embodiment. The computer system 100 includes a ransomware defense server system 150, an enterprise computer system 102 protected by a ransomware defense system 130, and one or more endpoint devices 106-108. While one instance is shown of the ransomware defense server system 150 and the enterprise computer system 102, the computer system 100 may include one or multiple instances.

The ransomware defense server system 150, enterprise computer system 102, and endpoint device/s 106-108 communicate over one or more networks. The network/s may include one or more local area networks (LANs) and/or one or more wide area networks, such as the Internet. The network arrangement of the ransomware defense system 130, enterprise computer system 102, and endpoint device/s 106-108 may vary.

The enterprise computer system 102 includes one or more computer systems owned by, operated by, and/or under the control of an enterprise. In some embodiments, the enterprise computer system 102 is deployed within an enterprise network, which may include one or more virtual private networks (VPNs). As an alternative and/or addition, one or more enterprise computer systems 102 may be deployed outside of an enterprise network, such as in cloud infrastructure.

The enterprise computer systems 102 may be accessed by one or more enterprise endpoint device/s 106. Enterprise endpoint device/s 106 are owned by, operated by, and/or controlled by an enterprise and/or its employees. As an alternative and/or addition, one or more enterprise computer systems 102 may be accessed by one or more customer endpoint device/s 108. For example, when the enterprise computer system 102 includes a web server system, a customer endpoint device 108 may interact with the web server system using a browser or a web-based application executing on the customer endpoint device 108. Other enterprise computer systems may also access the enterprise computer system 102.

A ransomware defense system 130 is deployed on the enterprise computer system 102. An enterprise computer system 102 on which the ransomware defense system 130 is deployed is also referred to herein as a protected enterprise computer system 102. In some embodiments, the ransomware defense system 130 is deployed on a set of selected enterprise computers, such as hardware and/or virtual computers involved in the deployment of one or more critical applications of the enterprise. The ransomware defense system 130 protects an enterprise computer system 102 from malicious actors, such as ransomware agents. The ransomware defense system 130 may be configured to detect ransomware activity and respond to the detection of ransomware activity to prevent or mitigate an attack. While enterprise computer systems are referenced in the context of one or more embodiments, it is to be understood that the techniques described herein may be adapted to analyze and/or protect any computer system without departing from the spirit or the scope of the disclosure.

The ransomware defense system 130 may include one or more components, such as but not limited to a kernel monitoring component 120, a ransomware detection component 132, and a ransomware response component 134. The ransomware defense system 130 and/or its components (e.g., kernel monitoring component 120, ransomware detection component 132, ransomware response component 134) may refer to executable code, an application comprising the executable code, and/or an instance of the application running in memory. The components of the ransomware defense system 130 may: include distinct and/or shared processes; execute as one or multiple applications, which may each execute as one or multiple application instances; execute on one or multiple computer systems; and be deployed within any system architecture, such as but not limited to a distributed system architecture, a cloud system architecture, a virtual system architecture, and/or a traditional physical network architecture. In some embodiments, an instance of the ransomware defense system 130 is deployed on each hardware and/or virtual computer to be protected in an enterprise computer system 102. For example, an instance of the kernel monitoring component 120 may be deployed in the kernel space of each hardware and/or virtual computer, as described in greater detail hereinafter.

### Kernel Monitoring Component

The kernel monitoring component 120 monitors system calls initiated by processes executing on one or more hardware computers and/or virtual computers of the enterprise computer system 102. The kernel monitoring component 120 may generate kernel telemetry data describing one or more system calls.

In some embodiments, the kernel monitoring component 120 is configured to generate kernel telemetry data corresponding to one or more system calls. In some embodiments, the kernel telemetry data corresponding to a system call may associate a process invoking the system call, an operation type of the system call, and a target of the system call. As used herein, the term “kernel telemetry data” may refer to the kernel telemetry data as originally generated by the kernel monitoring component 120 and/or kernel telemetry data that has been processed. For example, kernel telemetry data may include kernel telemetry data that has been transformed, filtered, aggregated, formatted, or otherwise processed. The kernel telemetry data may be used by the ransomware defense system 130 to detect ransomware activity, deflect ransomware activity, evaluate the performance of one or more ransomware defenses, and/or for other related purposes, as described in greater detail hereinafter.

The kernel telemetry data describes kernel-level behavior associated with one or more system call events initiated by applications and/or processes executing on the enterprise computer system 102. For example, the kernel telemetry data may describe aspects of one or more process control calls, memory management calls, device management calls, information maintenance calls, communication calls, or any other system call. In some embodiments, the kernel telemetry data may describe file system calls that involve one or more storage resource/s 104. The storage resource/s 104 may include any form of persistent data storage, such as but not limited to physical hard disks, solid-state drives (SSDs), virtual disks, network-attached storage (NAS), cloud-based storage services, and/or any other persistent storage device or technology capable of storing digital data.

In some embodiments, the kernel telemetry data collected by the kernel monitoring component 120 may include process information, such as a process identifier (PID), a thread identifier (TID), a user or group ID associated with the process, and/or parent process information. As an alternative and/or addition, the kernel telemetry data may include an action type describing the type of operation or service being requested, such as specific process management operations, file and/or file system operations, memory management operations, inter-process communication operations, network operations, device or hardware interactions, security and permissions operations, system management operations, or other types of actions. As an alternative and/or addition, the kernel telemetry data may include one or more arguments and/or parameters passed to the system call. As an alternative and/or addition, the kernel telemetry data may include a target of the requested action, such as one or more processes, files and/or directories, memory regions, devices, network addresses, registry keys, system settings, and kernel resources. As an alternative and/or addition, the kernel telemetry data may include any other data relating to the system call.

In some embodiments, the kernel monitoring component 120 is configured to operate based on telemetry configuration settings provided by the ransomware defense server system 150. For example, the ransomware defense system 130 may obtain telemetry configuration settings from a configuration server system 136 of the ransomware defense server system 150, as described in greater detail hereinafter.

In some embodiments, the kernel monitoring component 120 makes the kernel telemetry data available to other components of the ransomware defense system 130. In some embodiments, the kernel monitoring component 120 may store the kernel telemetry data in an event database 140 configured to store kernel telemetry data describing system call events initiated at the enterprise computer system 102. As used herein, the term “database” refers to one or more data stores for at least one set of data. A data store may include one or more tangible and/or virtual data storage locations, which may or may not be physically co-located. A simple example of a database is a text file used to store information about a set of data. Another example of a database is one or more data stores that are maintained by a server that processes requests to perform operations on the database. In some embodiments, the event database 140 includes a database management system (DBMS).

In some embodiments, the kernel monitoring component 120 executing on a particular computer stores the kernel telemetry data in an event database 140 at the particular computer, making the event database 140 available to other components of the ransomware defense system 130 executing at the particular computer. As an alternative and/or addition, the kernel monitoring component 120 of a particular computer may provide kernel telemetry data directly to another component of the ransomware defense system 130 executing at the particular computer. As an alternative and/or addition, another component of the ransomware defense system 130 may process kernel telemetry data and store kernel telemetry data corresponding to one or more system call events in the event database 140. As an alternative and/or addition, an event database 140 may store kernel telemetry data corresponding to one or multiple computers. In some embodiments, the event database 140 is an endpoint of one or more data pipelines configured to extract, transform, and/or load kernel telemetry data. For example, a data pipeline for handling kernel telemetry data may be implemented by the ransomware defense system 130.

### Ransomware Detection Component

The ransomware detection component 132 of the ransomware defense system 130 is configured to detect ransomware activity based on the kernel telemetry data generated by the kernel monitoring component 120. Ransomware activity may include activity performed by a ransomware agent in carrying out its objectives. In some embodiments, the ransomware detection component 132 detects ransomware activity by determining that a particular process executed under the control of a ransomware agent based on the kernel telemetry data.

In some embodiments, the ransomware detection component 132 analyzes the kernel telemetry data to detect one or more patterns of kernel-level behavior consistent with ransomware activity, also referred to herein as hallmarks. The ransomware detection component 132 may determine that a process executed under the control of a ransomware agent by detecting a hallmark in the kernel telemetry data associated with the process. A hallmark may comprise a pattern of kernel-level behavior that is based on one system call event or a set of multiple system call events.

Hallmarks may differentiate ransomware activity from legitimate activity by legitimate applications and/or users. For example, legitimate applications and/or users generally perform a specific purpose on specific types of files with a low degree of randomness in their behavior. Furthermore, legitimate applications/users generally do not take evasive actions, and generally do not interfere with the execution of other applications, including applications that protect the enterprise computer system 102. As another example, legitimate applications/users generally take care to avoid file system errors, file corruption, and other issues that could compromise data integrity and/or system stability.

In some embodiments, one or more hallmarks correspond to ransomware activity related to files and directories. For example, one or more hallmarks may be based on patterns of kernel-level behavior related to file access and/or network activity relating to file discovery (such as crawling or scanning directories to identify files), file modification, file encryption, data exfiltration, and/or other operations related to file and/or directory access. In some embodiments, hallmarks may be based on a pattern comprising an ordered series of specific operations, such as: reading a file, writing a separate file, and then deleting the original file; reading a file, modifying the file, and then closing the file; and/or other ordered series of operations.

As an alternative and/or addition, one or more hallmarks may correspond to ransomware activity related to system configuration settings. For example, one or more hallmarks may be based on patterns of kernel-level behavior related to modification of system configuration data, including system configuration files, registry settings, security features, privileges, permissions, and/or other system configuration data. As another example, one or more hallmarks may correspond to ransomware activity related to system configuration settings. For example, one or more hallmarks may be based on patterns of kernel-level behavior related to modifying access control configurations.

As an alternative and/or addition, one or more hallmarks may correspond to ransomware activity related to process execution. For example, one or more hallmarks may be based on patterns of kernel-level behavior observable in system calls related to terminating and/or modifying processes such as critical processes, system processes, processes related to security measures, processes related to defensive mechanisms, and/or other processes. As another example, one or more hallmarks may be based on patterns of kernel-level behavior observable in system calls related to memory manipulation, code injection techniques, executing unauthorized binaries or other unauthorized code, and/or other operations related to process execution by a ransomware agent.

As an alternative and/or addition, one or more hallmarks may correspond to other ransomware activity. For example, one or more hallmarks may be based on patterns of kernel-level behavior observable in system calls related to ransom note display, ransomware propagation, ransomware activity cover-up, anti-detection behavior, anti-security behavior, and/or operations related to activity performed by a ransomware agent. As another example, one or more hallmarks may be based on patterns of kernel-level behavior associated with a particular ransomware variant.

In some embodiments, one or more hallmarks correspond to deviating from typical kernel-level behavior previously observed for a particular process. When a legitimate process deviates from its typical pattern of kernel-level behavior, the legitimate process may be acting under the control of the ransomware agent, such as due to code injection, process manipulation, API hooking, privilege escalation, and/or other techniques. In some embodiments, the kernel monitoring component 120 is configured to observe one or more legitimate processes to determine typical kernel-level behavior for a known process, and one or more hallmarks may include a pattern of deviation from the typical kernel-level behavior.

In some embodiments, the ransomware detection component 132 is configured to operate based on detection configuration settings provided by the ransomware defense server system 150. For example, the ransomware defense system 130 may obtain detection configuration settings from a configuration server system 136 of the ransomware defense server system 150, as described in greater detail hereinafter.

### Ransomware Response Component

The ransomware response component 134 of the ransomware defense system 130 is configured to respond to ransomware activity based on the kernel telemetry data generated by the kernel monitoring component 120. In some embodiments, the ransomware response component 134 initiates one or more response procedures when ransomware activity is detected. For example, the ransomware response component 134 may initiate one or more response procedures in response to determining that a particular process executed under the control of the ransomware agent. The response procedures may include actions to mitigate and/or prevent the spread of any ransomware, such as terminating the process, taking the computer on which the process executed offline, otherwise isolating the process and/or the computer, restricting permissions, blocking access to sensitive data, blocking network access, or other responsive actions. In some embodiments, the ransomware response component 134 may implement advanced countermeasures such as dynamic resource throttling, deceptive file systems, or redirecting ransomware activity to honeypot environments for further analysis. These procedures aim to minimize damage, ensure continuity of operations, and enhance overall system resilience against ransomware threats.

In some embodiments, the one or more response procedures include preventing execution of the system call. For example, the ransomware defense system 130 may be configured to prevent execution of a system call associated with the particular process when a hallmark is detected. For example, the kernel monitoring component 120 may intercept a system call and generate kernel telemetry data for the system call when the system call is invoked. The kernel monitoring component 120 may enforce conditional execution by requiring clearance from the ransomware detection component 132 before allowing the system call to execute normally without modification. The ransomware detection component 132 may allow execution of a system call to proceed when no hallmark is detected in the corresponding kernel telemetry data. When the ransomware detection component 132 detects a hallmark, the ransomware defense system 130 may deny the system call, modify the system call, simulate execution of the system call by fabricating a return value without actually executing the system call, hold the system call for further analysis, or otherwise alter execution of the system call. In some embodiments, at least a portion of the ransomware response component 134 is integrated with the kernel monitoring component 120 in kernel space to handle system calls associated with a ransomware agent.

In some embodiments, the one or more response procedures include initiating a remediation process to address ransomware on the computer system. For example, the ransomware response component 134 may be configured to automatically perform one or more remediation processes, such as isolating one or more applications, systems, and/or resources. As an alternative and/or addition, the ransomware response component 134 may be configured to automatically determine and/or report on potentially affected applications, systems, and/or resources. The ransomware response component 134 may use kernel telemetry data, such as kernel telemetry data stored in the event database 140 to perform one or more automatic remediation processes.

In some embodiments, the one or more response procedures include notifying one or more systems and/or response teams for handling cybersecurity breaches. For example, the ransomware response component 134 may be configured to notify an incident response team. The incident response team may evaluate the scope of the ransomware attack, identify affected systems and resources, contain the ransomware threat, and/or initiate recovery processes such as restoring encrypted files from backups, rolling back the system state to a pre-infection snapshot, or applying security patches to remediate exploited vulnerabilities.

In some embodiments, the ransomware response component 134 is configured to operate based on response configuration settings provided by the ransomware defense server system 150. For example, the ransomware defense system 130 may obtain response configuration settings from a configuration server system 136 of the ransomware defense server system 150, as described in greater detail hereinafter.

### Example Implementation

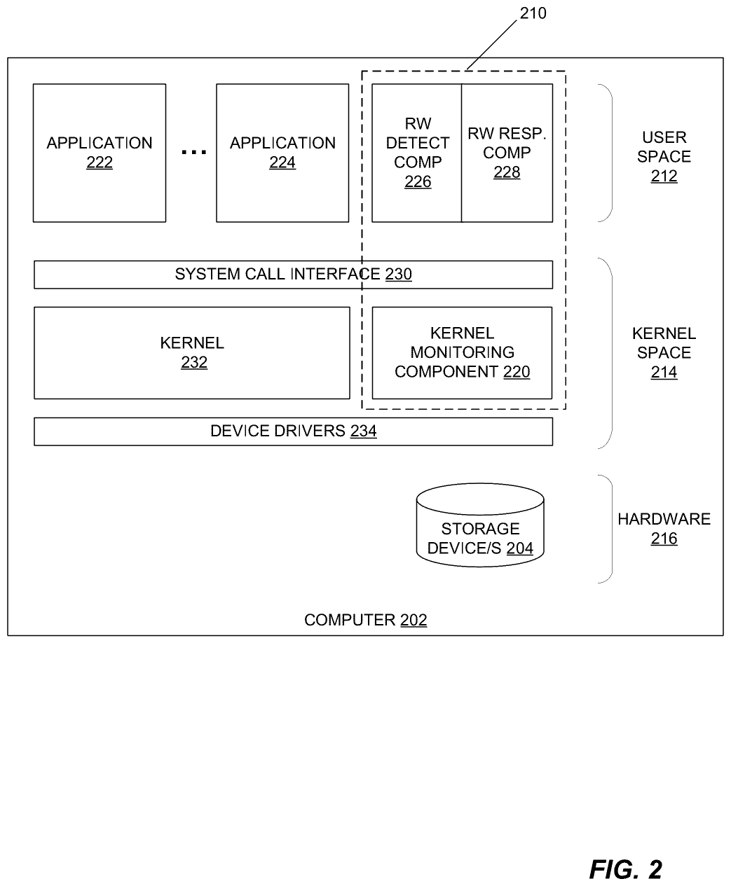

FIG. 2 illustrates a protected computer in an example embodiment. The computer 202 may be a hardware computer. As an alternative and/or addition, the computer 202 may be a virtual computer. For example, the computer 202 may be a virtual machine configured to emulate a hardware computer. One or more techniques described herein may be adapted to a hypervisor and/or other virtual machine architecture components without departing from the spirit or the scope of the disclosure.

The computer 202 includes user space 212 and kernel space 214. The user space 212 is a portion of the memory of the computer 202 where user-mode applications 222-224 run. That is, the processes corresponding to the user-level applications 222-224 execute within user space 212. The user space 212 typically contains the code, data, and stack of the applications 222-224.

The kernel space 214 is a dedicated portion of the memory of the computer 202 that is reserved for the operating system's kernel and other components. The kernel space 214 typically contains core components of the operating system, such as the kernel 232, device drivers 234, and critical system data structures. Access to the kernel space is restricted from user space 212. Kernel-level operations may execute in a privileged mode and may access system functions and resources directly. For example, kernel-level processes may have unrestricted file system and memory access, handle system calls, manage interrupts, execute privileged instructions, override user space permissions, and use other kernel-mode privileges.

Applications 222-224 executing in user space 212 utilize the system call interface 230 to access lower-level components. The system call interface 230 is a programming interface that enables user-level applications 222-224 to request services and functionality from the operating system's kernel 232. For example, the applications 222-224 can initiate system calls to access resources within the kernel space 214, such as but not limited to device drivers 234, critical kernel data structures, kernel code, memory management services, file systems, networking functionalities, and process and thread management features. The device drivers 234 and/or other components of the kernel space 214 facilitate interactions between user space 212 components and the hardware 216 of the computer 202. The hardware 216 and/or other hardware-level resources may be hardware and/or virtual resources.

The computer 202 is protected by a ransomware defense system 210. In some embodiments, the ransomware defense system 210 includes a kernel monitoring component 220 that executes in kernel space 214. Processes in kernel space 214, including one or more processes of the kernel monitoring component 220, have privileged access to the memory of other processes within the kernel space 214. The kernel monitoring component 220 may be implemented as a kernel-level extension, such as but not limited to a driver, a kernel module, and/or a kernel filter. In some embodiments, the kernel monitoring component 220 is implemented as an I/O intercepting module, such as but not limited to a minifilter driver compatible with the Windows file system or an extended Berkeley packet filter (eBPF) logic.

The kernel monitoring component 220 may be configured to monitor one or more processes executing on the computer 202, such as by collecting kernel telemetry data describing one or more system calls initiated by one or more processes executing in user space 212 and/or kernel space 214. The kernel monitoring component 220 may be configured to collect kernel telemetry data on all system calls. As an alternative and/or addition, the kernel monitoring component 220 may be configured to collect kernel telemetry data on specific system calls and/or specific processes. As an alternative and/or addition, the kernel monitoring component 220 may be configured to filter data collection. In some embodiments, the collection of kernel telemetry data may be based on telemetry configuration settings, including telemetry configuration settings obtained from a ransomware defense server system (e.g., ransomware defense server system 150).

In some embodiments, the ransomware defense system 210 includes one or more application components 226-228 that execute in user space 212, such as a ransomware detection component 226 and/or ransomware response component 228. The application component/s 226-228 may implement features of the ransomware defense system 210 that do not require kernel privileges. For example, the application component/s 226-228 may be configured to receive, filter, transform, aggregate, format, or otherwise handle kernel telemetry data collected by the kernel monitoring component 220. In some examples, the kernel monitoring component 220 and/or the application component/s 226-228 may implement data pipeline functionality for handling kernel telemetry data. In some embodiments, the application component/s 226-228 of the ransomware defense system 210 are configured to detect ransomware activity based on the kernel telemetry data and/or respond to detected ransomware activity.

In some embodiments, the application component/s 226-228 of the ransomware defense system 210 are configured to communicate with a ransomware defense server system (e.g., ransomware defense server system 150). For example, the application component/s 226-228 may transmit kernel telemetry data to the ransomware defense system, periodically update the ransomware defense server system on its operational status, poll the ransomware defense server system for configuration setting updates (e.g., telemetry configuration data, detection configuration data, response configuration data, and/or other configuration data), or otherwise communicate with the ransomware defense server system.

While this example embodiment depicts a division of ransomware defense system 210 operations between the application component/s 226-228 and the kernel monitoring component 220, this division is not required. Furthermore, the specific division of operations described between the application component/s 226-228 and the kernel monitoring component 220 may differ from the described division.

### Ransomware Defense Server System

Returning to FIG. 1, in some embodiments, the ransomware defense server system 150 is configured to support the operation of the ransomware defense system 130 at the enterprise computer system 102. The ransomware defense server system 150 may support one or multiple instances of the ransomware defense system 130 at one or multiple enterprise computer systems 102.

In some embodiments, the ransomware defense server system 150 provides configuration settings for one or more instances of the ransomware defense system 130. For example, the ransomware defense server system 150 may include a configuration server system 136 configured to provide telemetry configuration settings, detection configuration settings, response configuration settings, and/or other configuration settings for one or more components of the ransomware defense system 130. The telemetry configuration settings, detection configuration settings, response configuration settings, and/or other configuration settings provided to one instance of a ransomware defense system 130 may be the same or different from the configuration settings provided to another instance. In some embodiments, an instance of the ransomware defense system 130 is configured to poll the ransomware defense server system 150 for configuration setting updates (e.g., telemetry configuration data, detection configuration data, response configuration data, and/or other configuration data). As an alternative and/or addition, an instance of the ransomware defense system 130 may be configured to provide the ransomware defense server system 150 status information regarding the defense of a corresponding enterprise computer system 102.

The ransomware defense server system 150 may determine configuration settings based on analyzing kernel telemetry data corresponding to ransomware, including new ransomware variants. For example, the ransomware defense server system 150 may include a ransomware behavior analysis system 138. The ransomware behavior analysis system 138 is configured to analyze the execution of one or more ransomware variants and generate one or more hallmarks comprising one or more patterns of kernel-level behavior consistent with specific ransomware variants. The ransomware behavior analysis system 138 is described in greater detail in co-pending U.S. application Ser. No. 19/040,454, filed on Jan. 29, 2025, the entire contents of which are hereby incorporated by reference as if fully set forth herein.

In some embodiments, the ransomware defense system 130 of an enterprise computer system 102 may provide the ransomware defense server system 150 with kernel telemetry data for analysis at the ransomware defense server system 150. The ransomware defense server system 150 may analyze the kernel telemetry data to detect ransomware, evaluate patterns over time, detect new threats, and/or perform other related functions. In some embodiments, the ransomware defense server system 150 analyzes kernel telemetry data collected from multiple In some embodiments, the configuration server system 136 monitors the lifecycle of individual instances of the kernel monitoring component 120. For example, an instance of the kernel monitoring component 120 may submit a periodic request to the configuration server system 136 at a regular interval. The request may include an operating status of the instance of the kernel monitoring component 120. As an alternative and/or addition, the configuration server system 136 may infer that the operating status of the instance is compromised or otherwise atypical based on the absence of the periodic request.

In some embodiments, the configuration server system 136 responds to the request with new configuration setting data to change the configuration settings of the instance of the kernel monitoring component 120. For example, the configuration server system 136 may provide a configuration identifier corresponding to a particular configuration file in response to the request from the instance of the kernel monitoring component 120. When the instance of the kernel monitoring component 120 receives the configuration identifier, the instance may use the configuration identifier to obtain the corresponding configuration file from the configuration server system 136 and/or the ransomware defense system 130. By employing a polling mechanism, the kernel monitoring component 120 may avoid exposing an application programming interface (API) for controlling the operation of the kernel monitoring component 120.

### Example Processes

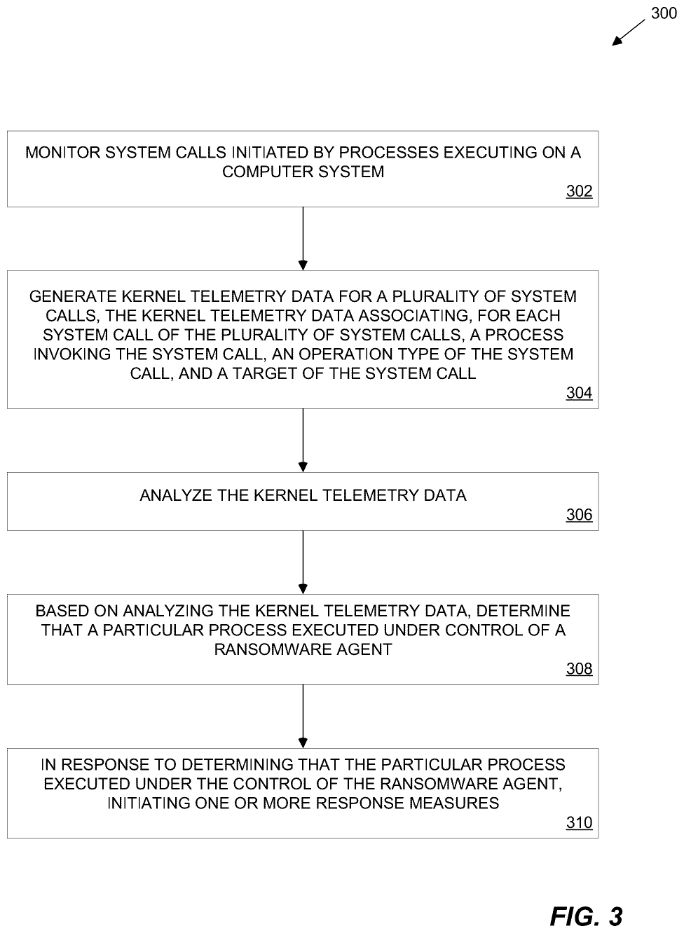

FIG. 3 is a flow diagram of a process for ransomware defense in an example embodiment. Process 300 may be performed by one or more computing devices and/or processes thereof. For example, one or more blocks of process 300 may be performed by computer system 400. In some embodiments, one or more blocks of process 500 are performed by a ransomware defense system executing on a hardware or virtual computer, such as the ransomware defense system 130 of FIG. 1. Process 300 will be described with respect to the ransomware defense system 130 of FIG. 1, but its performance is not limited thereto.

At block 302, the ransomware defense system 130 monitors system calls initiated by

At block 304, the ransomware defense system 130 generates kernel telemetry data for a plurality of system calls. The kernel telemetry data associates, for each system call of the plurality of system calls, a process invoking the system call, an operation type of the system call, and a target of the system call.

At block 306, the ransomware defense system 130 analyzes the kernel telemetry data.

At block 308, based on analyzing the kernel telemetry data, the ransomware defense system 130 determines that a particular process executed under control of a ransomware agent

At block 310, in response to determining that the particular process executed under the control of the ransomware agent, the ransomware defense system 130 initiates one or more response measures.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

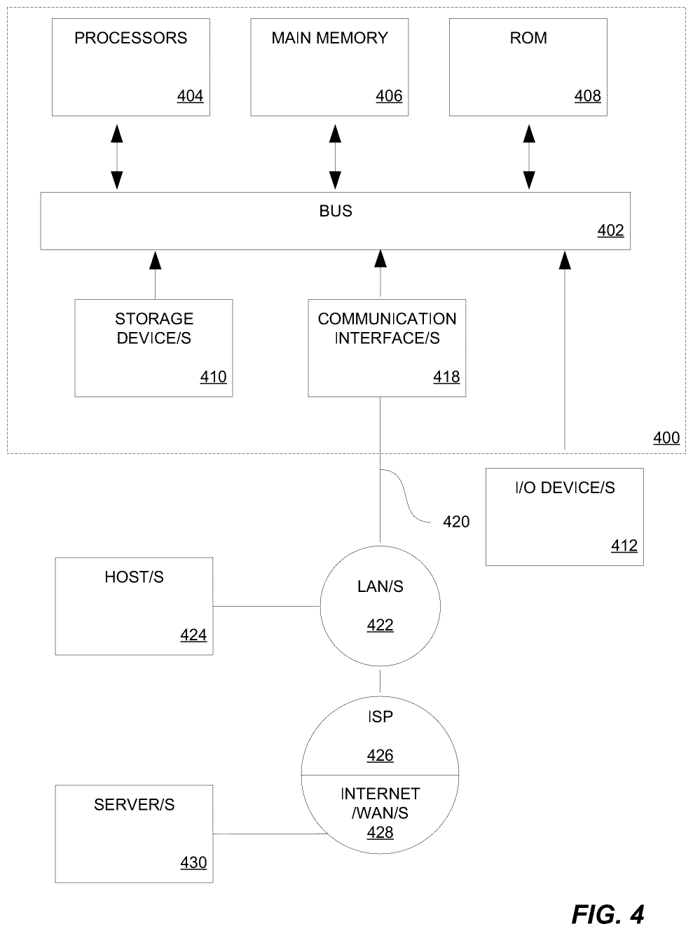

FIG. 4 is a block diagram that illustrates a computer system 400 upon which one or more embodiments described herein may be implemented. The computer system 400 includes a bus 402 or another communication mechanism for communicating information, and one or more hardware processors 404 coupled with bus 402 for processing information, such as computer instructions and data. The hardware processor/s 404 may include one or more general-purpose microprocessors, graphical processing units (GPUs), coprocessors, central processing units (CPUs), and/or other hardware processing units. As an alternative or addition, one or more computer systems 400 may be configured to provide a cloud computing environment, virtual machine, and/or other software-based emulation of a physical computing environment upon which one or more embodiments described herein may be implemented.

The computer system 400 also includes one or more units of main memory 406 coupled to the bus 402, such as random-access memory (RAM) or other dynamic storage, for storing information and instructions to be executed by the processor/s 404. Main memory 406 may also be used for storing temporary variables or other intermediate information during execution of instructions to be executed by the processor/s 404. Such instructions, when stored in non-transitory storage media accessible to the processor/s 404, turn the computer system 400 into a special-purpose machine that is customized to perform the operations specified in the instructions. In some embodiments, main memory 406 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

The computer system 400 may further include one or more units of read-only memory (ROM) 408 or other static storage coupled to the bus 402 for storing information and instructions for the processor/s 404 that are either always static or static in normal operation but reprogrammable. For example, the ROM 408 may store firmware for the computer system 400. The ROM 408 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 410, such as a magnetic disk or optical disk, is provided and coupled to the bus 402 for storing information and/or instructions. The storage device/s 410 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 400 may be coupled via the bus 402 to one or more input/output (I/O) devices 412. For example, the I/O device/s 412 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 412 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 404 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 412 may include a device with combined I/O functionality, such as a touch-enabled display.

Other I/O device/s 412 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 404 over the bus 402.

The computer system 400 may implement the techniques described herein using customized hard-wired logic, one or more ASICs or FPGAs, firmware, and/or program logic that causes computer system 400 to be a special-purpose machine. According to one embodiment, the techniques herein are performed by the computer system 400 in response to the processor/s 404 executing one or more sequences of one or more instructions contained in main memory 406. Such instructions may be read into main memory 406 from another storage medium, such as the one or more storage device/s 410. Execution of the sequences of instructions contained in main memory 406 causes the processor/s 404 to perform the process steps described herein. In alternative embodiments, hard-wired circuitry may be used in place of or in combination with software instructions.

The computer system 400 also includes one or more communication interfaces 418 coupled to the bus 402. The communication interface/s 418 provide two-way data communication over one or more physical or wireless network links 420 that are connected to a local network 422 and/or a wide area network (WAN), such as the Internet. For example, the communication interface/s 418 may include an integrated services digital network (ISDN) card, cable modem, satellite modem, or a modem to provide a data communication connection to a corresponding type of telephone line. Alternatively and/or in addition, the communication interface/s 418 may include one or more of: a local area network (LAN) device that provides a data communication connection to a compatible local network 422; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network; and other networking devices that establish a communication channel between the computer system 400 and one or more LANs 422 and/or WANs.

The network link/s 420 typically provides data communication through one or more networks to other data devices. For example, the network link/s 420 may provide a connection through one or more local area networks 422 (LANs) to one or more host computers 424 or to data equipment operated by an Internet Service Provider (ISP) 426. The ISP 426 provides connectivity to one or more wide area networks 428, such as the Internet. The LAN/s 422 and WAN/s 428 use electrical, electromagnetic, or optical signals that carry digital data streams. The signals through the various networks and the signals on the network link/s 420 and through the communication interface/s 418 are example forms of transmission media or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire, and fiber optics, including traces and/or other physical electrically conductive components that comprise the bus 402. Transmission media can also take the form of acoustic or light waves, such as those generated during radio-wave and infrared data communications.

Various forms of media may be involved in carrying one or more sequences of one or more instructions to the processor 404 for execution. For example, the instructions may initially be carried on a magnetic disk or solid-state drive of a remote computer. The remote computer can load the instructions into its main memory 406 and send the instructions over a telecommunications line using a modem. A modem local to the computer system 400 can receive the data on the telephone line and use an infrared transmitter to convert the data to an infrared signal. An infra-red detector can receive the data carried in the infra-red signal and appropriate circuitry can place the data on the bus 402. The bus 402 carries the data to main memory 406, from which the processor 404 retrieves and executes the instructions. The instructions received by main memory 406 may optionally be stored on the storage device 410 either before or after execution by the processor 404.

The computer system 400 can send messages and receive data, including program code, through the network(s), the network link 420, and the communication interface/s 418. In the Internet example, one or more servers 430 may transmit signals corresponding to data or instructions requested for an application program executed by the computer system 400 through the Internet 428, ISP 426, local network 422 and a communication interface 418. The received signals may include instructions and/or information for execution and/or processing by the processor/s 404. The processor/s 404 may execute and/or process the instructions and/or information upon receiving the signals by accessing main memory 406, or at a later time by storing them and then accessing them from the storage device/s 410.

### Other Aspects of Disclosure

Although the concepts herein have been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

What is claimed is:

1. A non-transitory computer-readable medium storing instructions that, when executed by one or more processors, cause the one or more processors to:
monitor system calls initiated by processes executing on a computer system;
generate kernel telemetry data for a plurality of system calls, the kernel telemetry data associating, for each system call of the plurality of system calls, a process invoking the system call, an operation type of the system call, and a target of the system call;
analyze the kernel telemetry data;
based on analyzing the kernel telemetry data, determine that a particular process executed under control of a ransomware agent; and
in response to determining that the particular process executed under control of the ransomware agent, initiate one or more response measures.

2. The non-transitory computer-readable medium of claim 1:
wherein monitoring the system calls is performed in kernel space of the computer system;
wherein the instructions, when executed by one or more processors, cause the one or more processors to: provide the kernel telemetry data to a user space application component executing in user space of the computer system; and
wherein analyzing the kernel telemetry data is performed by the user space application component.

3. The non-transitory computer-readable medium of claim 1:
wherein determining that the particular process executed under control of the ransomware agent comprises detecting a hallmark in particular kernel telemetry data corresponding to the particular process, the hallmark comprising a first pattern of kernel-level behavior consistent with ransomware execution.

4. The non-transitory computer-readable medium of claim 3:
wherein the hallmark comprises a pattern of kernel-level behavior associated with a particular ransomware variant.

5. The non-transitory computer-readable medium of claim 3:
wherein the hallmark comprises deviation from typical kernel-level behavior of the particular process.

6. The non-transitory computer-readable medium of claim 3:
wherein the hallmark comprises a pattern of file access relating to file encryption.

7. The non-transitory computer-readable medium of claim 3:
wherein the hallmark comprises a pattern of file access relating to exfiltration of data.

8. The non-transitory computer-readable medium of claim 3:
wherein the hallmark comprises modification of system configuration data.

9. The non-transitory computer-readable medium of claim 3:
wherein the hallmark comprises a pattern associated with modifying one or more processes related to security.

10. The non-transitory computer-readable medium of claim 3:
wherein the hallmark comprises a pattern associated with modifying access control configurations.

11. The non-transitory computer-readable medium of claim 1:
wherein the one or more response measures comprise preventing execution of a corresponding system call associated with the particular process.

12. The non-transitory computer-readable medium of claim 1:
wherein the one or more response measures comprises terminating the particular process.

13. The non-transitory computer-readable medium of claim 1:
wherein the one or more response measures comprise initiating a remediation process to address ransomware on the computer system.

14. A method comprising:
monitoring system calls initiated by processes executing on a computer system;
generating kernel telemetry data for a plurality of system calls, the kernel telemetry data associating, for each system call of the plurality of system calls, a process invoking the system call, an operation type of the system call, and a target of the system call;
analyzing the kernel telemetry data;
based on analyzing the kernel telemetry data, determining that a particular process executed under control of a ransomware agent; and
in response to determining that the particular process executed under control of the ransomware agent, initiating one or more response measures;
wherein the method is performed by one or more processors.

15. The method of claim 14:
wherein monitoring the system calls is performed in kernel space of the computer system;
the method comprising:
providing the kernel telemetry data to a user space application component executing in user space of the computer system; and
wherein analyzing the kernel telemetry data is performed by the user space application component.

16. The method of claim 14:
wherein determining that the particular process executed under control of the ransomware agent comprises detecting a hallmark in particular kernel telemetry data corresponding to the particular process, the hallmark comprising a first pattern of kernel-level behavior consistent with ransomware execution.

17. The method of claim 16:
wherein the hallmark comprises a pattern of kernel-level behavior associated with a particular ransomware variant.

18. The method of claim 16:
wherein the hallmark comprises deviation from typical kernel-level behavior of the particular process.

19. The method of claim 16:
wherein the hallmark comprises at least one of:
a pattern of file access relating to file encryption;
a pattern of file access relating to exfiltration of data;
modification of system configuration data;
a pattern associated with modifying processes related to security; and
a pattern associated with modifying access control configurations.

20. A computer system comprising:
one or more hardware processors;
at least one memory storing one or more instructions which, when executed by the one or more hardware processors, cause the one or more hardware processors to:
monitor system calls initiated by processes executing on the computer system;
generate kernel telemetry data for a plurality of system calls, the kernel telemetry data associating, for each system call of the plurality of system calls, a process invoking the system call, an operation type of the system call, and a target of the system call;
analyze the kernel telemetry data;
based on analyzing the kernel telemetry data, determine that a particular process executed under control of a ransomware agent; and
in response to determining that the particular process executed under control of the ransomware agent, initiate one or more response measures.
